(19) United States
(12) Patent Application Publication
(10) Pub. No.: US 2008/0022545 A1
(43) Pub. Date: Jan. 31, 2008

(54) Measurement making holes apparatus and method

(76) Inventor: Tom Paul Wirtz, Loveland, CO (US)

Correspondence Address: BARBER LEGAL, P.O. BOX 16220, GOLDEN, CO, 80402-6004, US

(21) Appl. No.: 11/827,899

(22) Filed: Jul. 14, 2007

Related U.S. Application Data
(63) Continuation-in-part of application No. 11/296,154, filed on Dec. 6, 2005, now abandoned.

(51) Int. Cl. G01B 3/10

(52) U.S. Cl. 33/759

(57) ABSTRACT

A measurement and marking device has a tape measure body bearing indicia of distance and a plurality of closely set small holes in two parallel lines. Larger holes mark each one inch distance. Because the holes are set in parallel lines, a closer spacing of holes may be achieved than if the holes were in a single line. A magnet may be provided on a tape measure housing, so as to hold small fasteners such as screws, staples or nails. A method of marking a distance comprises extending the tape, inserting a pencil or similar marking device through a hole at a desired distance and marking the distance through the hole. Sweeping the device through an angle will result in marking of an arc.

### CROSS-REFERENCE TO RELATED APPLICATIONS

This application claims the priority and benefit of U.S. Provisional Patent Application No. 60/632,718 filed Dec. 3, 2004 in the name of the same inventor, Thomas Paul Wirtz, and claims the priority and benefit of co-pending U.S. Utility patent application Ser. No. 11/296,154 filed Dec. 6, 2005 in the name of the same inventor, Thomas Paul Wirtz

### FIELD OF THE INVENTION

This invention relates generally to woodworking measurement, and specifically to measurement devices of the tape measure type.

### STATEMENT REGARDING FEDERALLY FUNDED RESEARCH

This invention was not made under contract with an agency of the US Government, nor by any agency of the US Government.

### BACKGROUND OF THE INVENTION

Woodworking, metal working, construction, carpentry and similar fields require frequent measurement of distances. Since working to a mark is considered a better practice than working directly from a measuring device, after making a distance measurement, a worker will typically desire to mark the distance measured before actually applying tools to the blank material of metal, plastic, wood or other materials.

In normal practice, a measuring tape, square or similar device is used. Because measuring tapes may conveniently roll into a compact package, measuring tapes are more common than squares or rulers or other similar devices, but the same general principle is involved. From a first point, a desired distance is measured. Indicia on the measuring device are consulted to located precisely the correct distance, and a small mark is made beside the measuring device. Finally, the item may be worked at the point or points marked.

Certain types of measurements are more difficult than others. For example, measuring and marking of an arc, so as to make a circular marking, requires either multiple measures and marks at slight angles to one another or else the use of a compass, string or similar device to hold the marking device in place.

However, in all such measuring and marking, and element of error is automatically created when the worker attempts to place a mark exactly beside the proper indicia. For starters, the mark must be offset to the side of the measuring device, which may place the mark slightly away from the desired location. A mark may also be accidentally misplaced upon occasion, for example if the pencil or other marking device slips a tiny fraction during the marking.

A search of patent office records indicate a fairly small number of items which attempt to make for easier measuring and marking either in relevant woodworking fields or in non-relevant areas such as cooking or textiles.

U.S. Pat. No. 1,145,244 issued to J. H. Hoffman on Jul. 6, 1915 teaches a tape measure with a large cross shaped hole located at each even one inch mark. That device teaches towards only one line of holes, and it would be virtually impossible to provide close set holes with the cross shaped hole of this invention.

U.S. Pat. No. 2,205,626 issued to F. E. Mason on Jun. 25, 1940 teaches a medical device for measuring the circumference of limbs: the tape measure of that invention appears to be flexible and teaches to a single line of hole disposed at ½ inch intervals. A pin is provided to slide through the holes, so the device teaches away from marking or anything else to do with woodworking.

U.S. Pat. No. 4,333,241 issued Jun. 8, 1982 to Wasik et al teaches a pasta bundle measuring device having holes which allow the device to be looped around to engage itself. (See FIG. 2.) It thus teaches away from marking and any form of woodworking.

U.S. Pat. No. 6,338,204 issued Jan. 15, 2002 to Howle teaches a tape measure used to find verticals and vertical distances. Two slits at the top allow it to be suspended from a nail, then a long slit extending the length of the device allows the user to mark a distance. However, there are no small apertures which precisely mark distances found, so this device shares the same inaccuracy as a conventional tape measure: the user must simply mark by eyeball beside the desired indicia of distance. Since the device also teaches away from two parallel lines of small holes, the device teaches away from the present invention.

U.S. Pat. No. 6,470,589 issued on Oct. 29, 2002 to Simmons teaches a measuring tape with three slits located near the tabbed end. The tabbed end may be folded over to engage the slits, thus making a loop at the end of the device for picking up objects at a distance. There is no indication of marking distances for the three slits, which may not have any set distance from the end in any case.

U.S. Pat. No. 6,826,845 issued Dec. 7, 2004 to Pritchard teaches a tape measure having an auxiliary mounting for a chalk line and a single line of holes through the tape measure. In use, the tape is extended with the chalk line on top of it, then a chalk line snap is done, hopefully leaving a line of chalk marks at each of the holes. The device teaches away from measuring and marking of a single distance, and since it teaches a single line of widely spaced holes, it teaches away from two lines of closely set holes.

U.S. Pat. No. 4,503,624 issued Mar. 12, 1985 to Whiteford teaches a carpenter's square having a stiff blade with multiple holes therethrough. Like all carpenter's squares, stiffness is fundamental to the principle of operation of the device: a flexible blade on a carpenter's square results in perpendicular lines drawn with the device wavering. (If elongated measurement is desired, a tape measure is used rather than a carpenter's square.) Thus aspects of the device of the '624 reference cannot be combined with flexible measuring devices without altering its fundamental principle of operation, which is provision of square, straight lines.

U.S. Pat. No. 4,914,830 issued Apr. 10, 1990 to Legare teaches a fairly standard tape measure having a single scribing hole therethrough but lacking an axis hole and lacking a plurality of rows each having a plurality of holes therein.

U.S. Pat. No. 4,924,597 issued May 15, 1990 to Tursi also teaches a tape measure lacking axis hole and lacking a plurality of rows, each row having a plurality of holes therein.

U.S. Pat. No. 6,305,093 issued Oct. 23, 2001 to Venola teaches a stiff “linear rail” having leveling bubbles and a stiff longitudinal ridge (for a handhold) which makes it impossible to function as a tape measure and impossible to use for measuring long distances.

It would be advantageous to provide a method of accurately and consistently measuring and marking wood, metal, construction, and plastic working distances.

It would further be advantageous to provide a device for accurately and consistently measuring and marking distances.

It would be advantageous to provide a method for measuring and marking straight lines.

It would be advantageous to provide a method for measuring and marking arcs.

It would further be advantageous to provide a device for measuring and marking woodworking arcs.

### SUMMARY OF THE INVENTION

### General Summary

A measurement and marking device has a tape measure body bearing indicia of distance and a plurality of closely set small holes in two parallel lines. The holes are set in parallel lines and staggered between the two lines so that a closer spacing of holes may be achieved than if the holes were in a single line. Thus holes may be used to mark distances as small as 1/16 of an inch or 1/32 of an inch or the like, in contrast to previous devices which could not allow closely set holes.

Larger holes mark at a regular larger distance such as one inch. By this means, a larger or more distinctive mark may be made at regular intervals if more than one mark may be made. This also assists the user in determining the correct hole to use, by providing a convenient reference from which to count 16ths or the like.

A magnet may be provided on a tape measure housing, so as to hold small fasteners such as screws, staples or nails. In use, the user may place on the magnet a few small screws they may have in hand at the moment that measurement becomes necessary.

A method of marking a distance comprises extending the tape, inserting a pencil or similar marking device through a hole at a desired distance and marking the distance through the hole. Larger marks may be made through the larger or differently shaped holes spaced at regular intervals. Another larger axis hole may be used with a pointed object such as a second pencil or a nail, as a convenient and exact axis about which to make an arc.

A method of marking a line at a distance from an edge comprises placing the hook at the end of the tape, inserting a pencil, pen or similar marking device through a hole at a desired distance, and drawing the device across the item to be marked while holding the device perpendicular to the edge.

Sweeping the device through an angle will result in marking of an arc, a useful method when a rounded shape is desired.

In embodiments, the device may have axis holes at certain locations as well as lines of holes for marking. Such axis holes may be used in conjunction with a second pencil or a nail or the like serving as an axis for an even more precise sweep during drawing of arcs.

### Summary in Reference to Claims

It is therefore a first aspect, advantage, objective and embodiment of the invention to provide a method of measuring and marking on an item, the method comprising the steps of:
providing a long flexible retractable tape measure having a plurality of holes arrayed in two straight parallel longitudinal lines, each line having holes arrayed at a distance of ⅛ inch distance, the two lines of holes offset by a longitudinal distance of 1/16 inch from each other, the tape measure having a first end and a second end;
placing the first end at a first point;
extending the flexible retractable tape measure second end to a length exceeding a first desired measurement from the first point;
locating one hole of the two lines of holes which hole is located at the first desired distance;
inserting the tip of a marking device through the located hole; and
scribing a mark on the item through the located hole.

It is therefore a second aspect, advantage, objective and embodiment of the invention to provide a method of measuring and marking on an item, further comprising:
maintaining the marking device in the located hole; while
rotating the tape measure about an axis located at the first point, the axis being a pointed object inserted through an axis hole in the tape measure at the first point; whereby
an arc is scribed on the item, the arc having a uniform distance from the first point.

It is therefore a third aspect, advantage, objective and embodiment of the invention to provide a method of measuring and marking on an item, further comprising:
after placing the first end at the first point, scribing a mark at the first end.

It is therefore another aspect, advantage, objective and embodiment of the invention to provide a working measurement and marking device comprising:
a housing;
a long flexible measure having a first extended position outside the housing and having a second retracted position within the housing;
a first line of holes passing through the flexible measure, the line straight and parallel to the length of the flexible measure, the holes of the first line of holes being disposed ⅛ inch apart, the holes of the first line having a first diameter.

It is therefore another aspect, advantage, objective and embodiment of the invention to provide a working measurement and marking device, further comprising:
a second line of holes passing through the flexible measure, the line straight and parallel to the length of the flexible measure, the holes of the second line of holes being disposed ⅛ inch apart, the holes of the second line having a second diameter, and the holes of the second line offset by a longitudinal distance of 1/16 inch from the holes of the first line whereby the holes of the two lines are staggered.

It is therefore another aspect, advantage, objective and embodiment of the invention to provide a woodworking measurement and marking device, wherein the first and second diameter are equal to 0.0625 inch.

It is therefore another aspect, advantage, objective and embodiment of the invention to provide a working measurement and marking device, wherein those holes of the first and second lines of holes which are located at an even measurement of 1 inch have a third diameter, the third diameter being larger than the first and second diameter.

It is therefore another aspect, advantage, objective and embodiment of the invention to provide a woodworking measurement and marking device, wherein the third diameter is 0.125 inch.

It is therefore another aspect, advantage, objective and embodiment of the invention to provide a working measurement and marking device, wherein the flexible measure further comprises:
a metal tape.

It is therefore another aspect, advantage, objective and embodiment of the invention to provide a working measurement and marking device, wherein the metal tape further comprises:
a plurality of indicia of distance.

It is therefore another aspect, advantage, objective and embodiment of the invention to provide a working measurement and marking device, wherein the housing further comprises:
a magnet.

It is therefore another aspect, advantage, objective and embodiment of the invention to provide a working measurement and marking device, further comprising:
third and fourth lines of holes.

It is therefore another aspect, advantage, objective and embodiment of the invention to provide a working measurement and marking device, further comprising:
a fifth line of holes, the first four lines of holes disposed on a first portion of the length of the flexible measure, the fifth line of holes disposed upon the flexible measure on a second portion of the length of the flexible measure.

It is therefore another aspect, advantage, objective and embodiment of the invention to provide a working measurement and marking device, further comprising:
an axis hole disposed separately from any line of holes.

It is therefore another aspect, advantage, objective and embodiment of the invention to provide a working measurement and marking device, wherein the long measure further comprises a length of at least 6 feet.

It is therefore another aspect, advantage, objective and embodiment of the invention to provide working measurement and marking device comprising:
a housing;
a flexible measure having a first extended position outside the housing and having a second retracted position within the housing, the flexible measure having first and second edges;
a first line of notches along the first edge of the flexible measure, the notches of the first line of notches being disposed ⅛ inch apart.

### BRIEF DESCRIPTION OF THE DRAWINGS

FIG. 1 is a partial top view of a first tape embodiment of the invention.

FIG. 2 is a partial bottom view of the first tape embodiment of the device.

FIG. 3 is a partial top view of a second tape embodiment of the device.

FIG. 4 is a partial bottom view of the second tape embodiment of the device.

FIG. 5 is a perspective view of a housing and magnet embodiment of the device.

FIG. 6 is a top view of a fourth embodiment of the invention in tape form, having axis holes for easier marking of arcs and circles.

FIG. 7 is a bottom view of the fourth embodiment of the invention.

FIG. 8 is a schematic diagram of various dimensions of the multiple lines of holes of the invention.

FIG. 9 is a top planform view of an extended portion of the long measuring device of the invention.

FIG. 10 is a top view of a the method of the invention of drawing a line parallel to an edge with the device of the invention.

FIG. 11 is a diagram showing another axis hole.

FIG. 12 is a planform diagram showing a section of the tame measure near the end, and an exemplary set of holes and marks suitable for the method and device of the present invention.

### INDEX OF REFERENCE NUMERALS

| | |
|---|---|
| First embodiment | 100 |
| Measure | 102 |
| First line of holes | 104 |
| Second line of holes | 106 |
| Larger hole | 108 |
| Distance indicia | 110 |
| Distance indicia | 112 |
| Second embodiment | 200 |
| Tape measure | 202 |
| First line of holes | 204 |
| Second line of holes | 206 |
| Larger hole | 208 |
| Distance indicia | 210 |
| Distance indicia | 212 |
| Notch | 214 |
| Fourth embodiment | 300 |
| First axis hole | 301 |
| Rule/measurement device | 302 |
| Second axis hole | 303 |
| First line of holes | 304 |
| Magnet | 305 |
| Second line of holes | 306 |
| Hook | 307 |
| Edge | 333 |
| Marking implement | 334 |
| First line of holes | 604 |
| Second line of holes | 606 |
| Line separation distance | 614 |
| First line hole separation distance | 616 |
| Second line hole separation distance | 618 |
| Measurement increment | 620 |
| First hole | 622 |
| First hole diameter | 624 |
| Second hole | 626 |
| Second hole diameter | 628 |
| First section (four lines) | 902 |
| Second section (one line) | 904 |
| Axis hole | 1102 |

### DETAILED DESCRIPTION

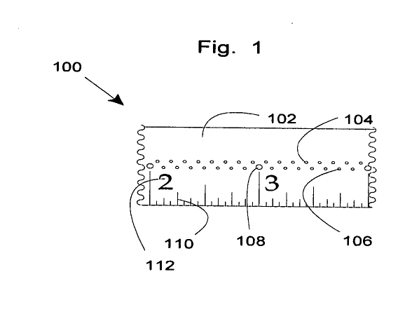

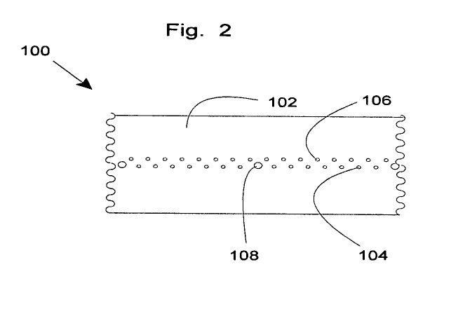

FIG. 1 is a partial top view of a first tape embodiment of the invention while FIG. 2 is a partial bottom view of the first tape embodiment of the device. The bottom of the device may be the same as the top of the device but without indicia, in embodiments indicia may be provided on both sides.

The measuring body of first embodiment 100 may be a straight, substantially flat and thin body 102 such as a tape measure (a thin flexible band of metal having a slight curvature in lateral cross section which allows it to stay straight under its own weight). The term “long” has used herein indicates a useful measuring length of at least 6 feet (72 inches, ˜183 cm.) which allows useful work for measuring and marking larger items. The term “long” does not include items such as T-squares or carpenter's squares which are typically less than 3 feet (36 inches, ˜91 cm.) long, and which are not tape measures and may not be used for useful measurement of distances greater than their own short lengths.

Measure 102 may have a straight first line of holes 104 and a second parallel line of holes 106. The holes of the second line 106 may be offset both laterally by a separation distance between the two lines, and may also be offset longitudinally, so that the individual holes of the two lines are staggered. By this means, two lines of holes having a hole to hole separation distance of ⅛ inch may provide a hole at every 1/16 of distance. In embodiments, the marks on the device may measure centimeters, with smaller marks representing millimeters, fractions of a centimeter and so on. Thus, a hole separation distance of 1 millimeter may be provided with a hole at every 0.5 millimeter in one line or the other, or a separation distance of 2 millimeters may be depicted by FIG. 1, with hole thus provided at every 1 millimeter in one line or the other.

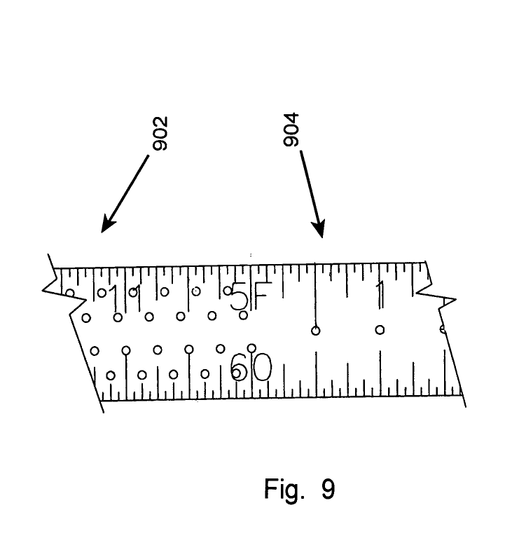

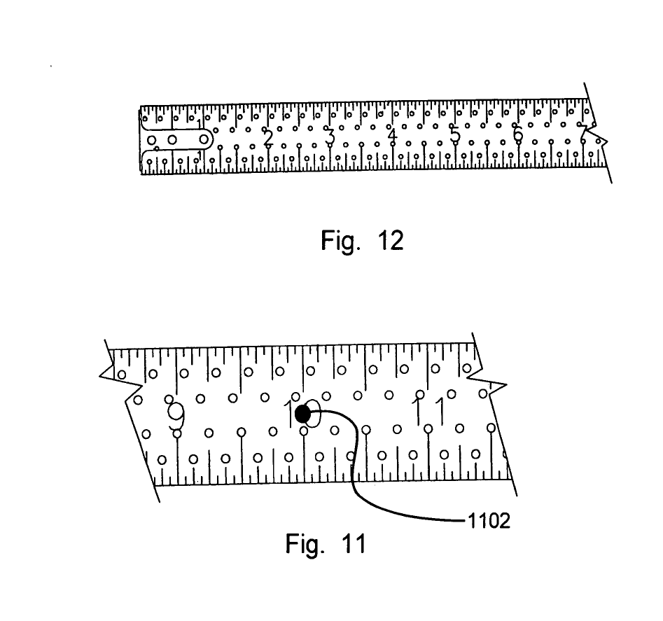

In alternative embodiments, additional lines of holes may be provided. For example, if four lines of holes are provided, then each line of holes may have a separation distance of ⅛ inch, but the staggered four lines of holes may provide a hole in one line or another at a distance of 1/32 of an inch. (For reference, FIGS. 11 and 12 both show four different lines of holes, while FIG. 9 shows five different lines of holes, all in addition to an axis hole.) It is worth noting that previous devices could not provide a separation this close with holes of usefully large size, as a single line of holes would not allow space for both the holes to penetrate the body and also for a webbing of body material to remain wide and strong between the holes.

Larger hole 108 may be disposed at a regular interval which is larger than or a multiple of the distance between the smaller holes. For example, a larger hole may be situated at every one inch/one centimeter, while smaller holes are located at a distance from each other of 1/16 of an inch (approx. 1.5 millimeter) or one millimeter (approx. 0.04 inch). Other logical choices and combinations of measures and separations may be used.

Distance indicia 110 may indicate distances on the measurement device by means of markings while distance indicia 112 may indicate distances by means of ordinal numbering, lettering, Braille bumps or the like.

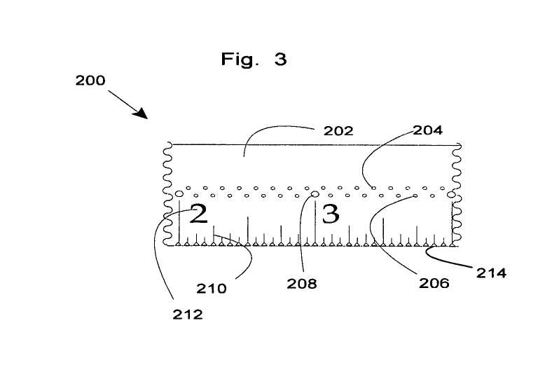

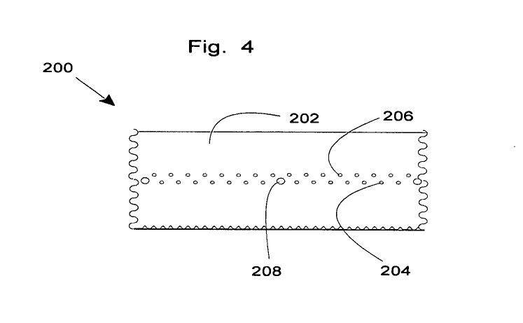

FIG. 3 is a partial top view of a second tape embodiment of the device. FIG. 4 is a partial bottom view of the second tape embodiment of the device.

Second embodiment 200 may have tape measure 202 having first line of holes 204 and second line of holes 206. Larger hole 208 may be disposed at a regular interval along the line, and may substitute for one member of the first or second line of smaller holes. In embodiments, the hole at greater interval may be the smaller hole, while the holes in the multiple lines may be larger. In yet other alternative embodiments, the shape of the holes may vary: a first shape for holes in the first line, but a second shape for the holes disposed at greater intervals (the “larger” holes). The second line of holes may share the first shape or may be yet a third shape. Distance indicia 210 and 212 may be as previously discussed.

The embodiment may also have notch 214, which may be one member of a line of notches as shown and may serve the same function as the holes of the lines of holes. The addition of a line of notches on one side or two lines of notches on two sides of the measure may be one convenient method of providing multiple lines: two lines of holes and two lines of notches may provide four lines of apertures, so that holes placed 1/16 inch apart, center to center, may be used to measure increments as small as 1/64 inch.

The line of notches may also replace one or both lines of holes.

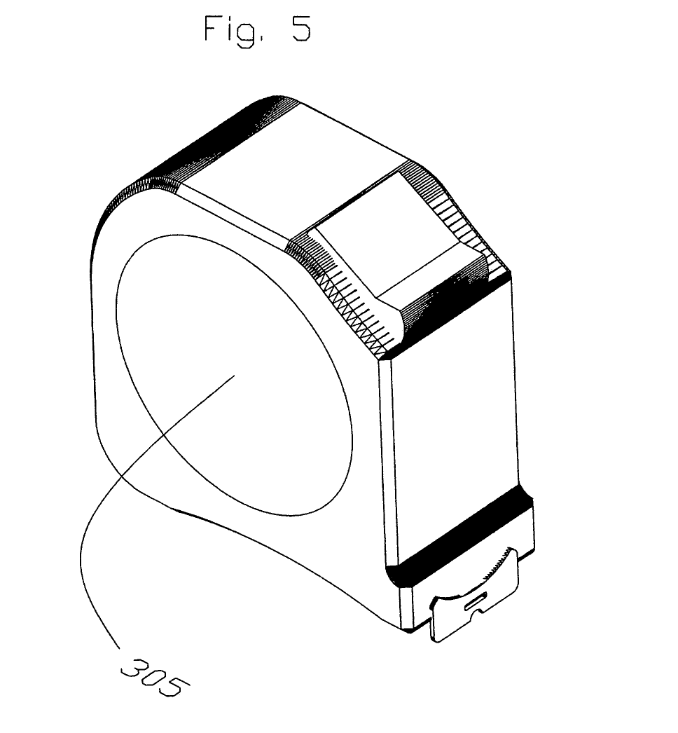

FIG. 5 is a perspective view of a housing and magnet embodiment of the device. The housing magnet 305 attached thereto, so that small metal objects such as nails, screws, staples or other small fasteners, screw or drill bits or the like may be adhered thereto for convenience.

The housing may contain a rewind mechanism as known for tape measure type devices. Note that for cloth tape embodiments, a housing may be dispensed with.

FIG. 5 is a perspective view of a housing and magnet embodiment of the device.

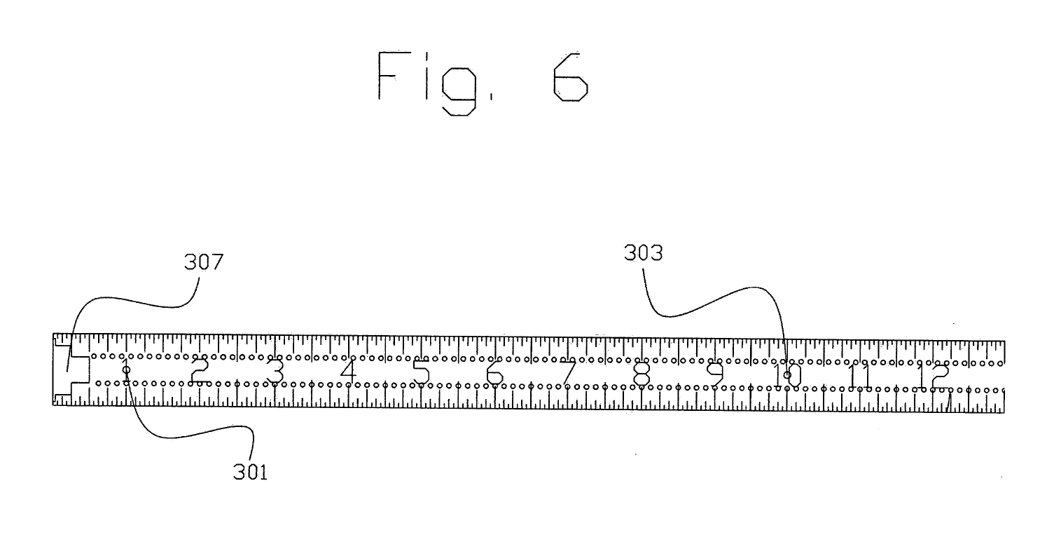

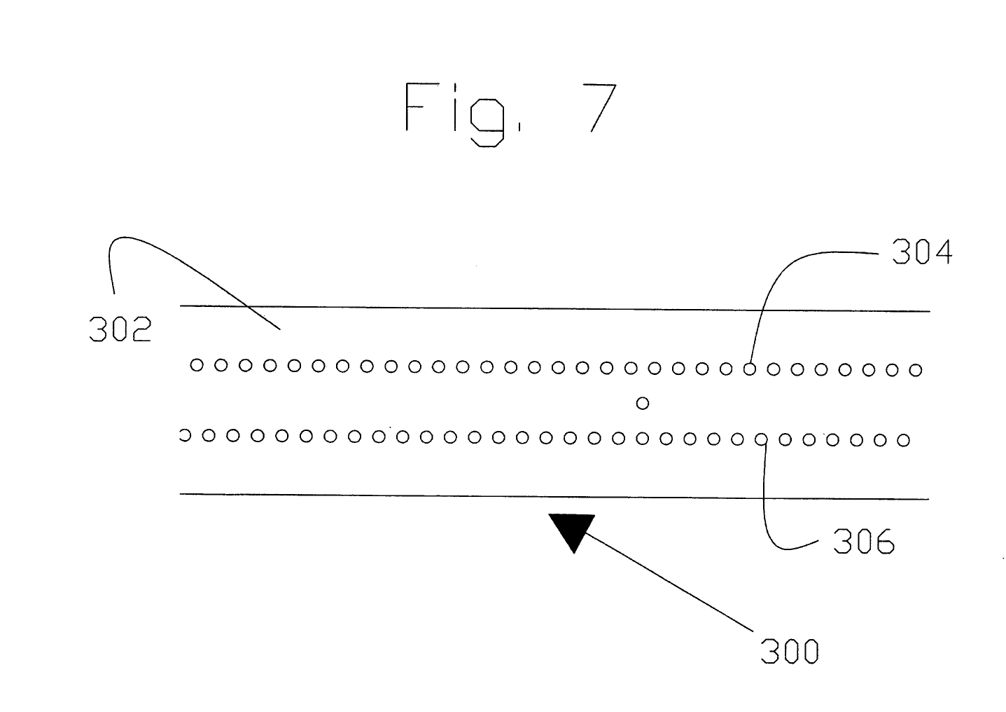

FIG. 6 is a top view of a fourth embodiment of the invention in tape form, having axis holes for easier marking of arcs and circles. FIG. 7 is a bottom view of the fourth embodiment of the invention. Fourth embodiment 300 has first axis hole 301 dimensioned and configured to accept a small axis device which the invention may then pivot about. For example, a small wood screw, a screw driver point or the like may be used as axes, as may other fasteners, marking devices and the like.

Rule/measurement body 302 may be a tape of metal, flexible polymer, cloth, composites and so on. Second axis hole 303 may be located at a different position along the length of the device from first axis hole 301. For example, first axis hole 301 may be located at or near the end of the measuring device body, depicted as the one inch point in the embodiment shown. Second axis hole 303 may be located at the ten inch mark, however, other convenient locations may be selected.

First line of holes 304 and second line of holes 306 may be seen in this embodiment to be of a uniform size.

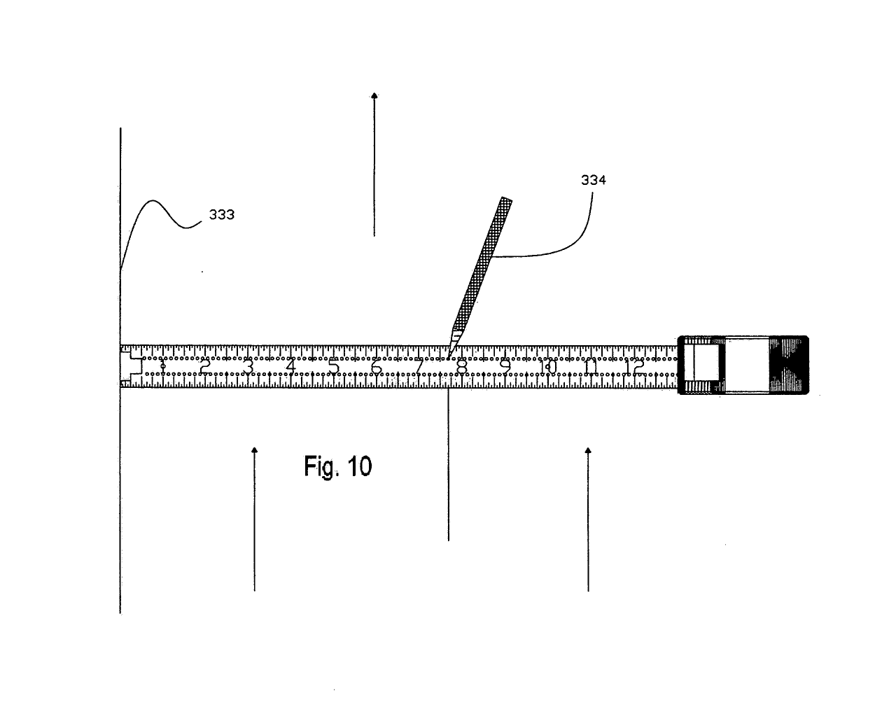

Hook 307 may project downward or upward from the tape measure body and allow the device to be used to scribe a straight line as discussed in reference to FIG. 10.

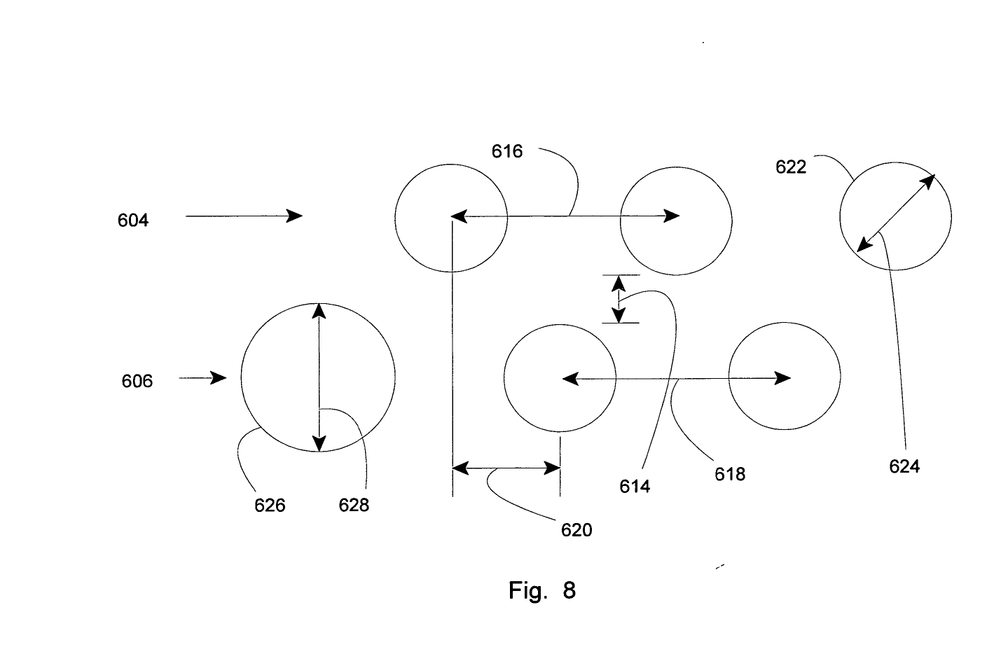

FIG. 8 is a schematic diagram of various dimensions of the multiple lines of holes of the invention.

First line of holes 604 and second line of holes 606 are laterally offset from each other by a line separation distance 614. First line hole separation distance 616 may represent the center to center separation distance of the holes of the first line, while second line hole separation distance 618 may represent the same distance for the holes of the second line. The two distances may be the same or different.

Measurement increment 620 may be smaller than either of the line's hole separation distances due to staggering of the two lines, thus providing a notably tighter spacing of the holes while still retaining a strong webbing of measuring body between the holes.

The line separation distances, hole diameters and other measures may be delimited in metric units rather than English units.

First hole 622 may have first hole diameter 624 while second hole 626 may have second hole diameter 628, which may be larger or small than first hole diameter 624. In embodiments, all holes may have a single diameter or shape, while in other embodiments, different holes may have different shapes or sizes.

At least four holes are preferred for each line of holes, as lower numbers of holes provides little useful measuring distance for a worker to use.

In the presently preferred embodiment and best mode presently contemplated for carrying out the invention, smaller holes may be disposed at intervals of ⅛ inch in each line, staggered to produce a measurement increment of 1/16 inch. Larger holes may be positioned at regular intervals of one inch, and may take the place of one hole of the lines of holes.

FIG. 9 is a planform diagram of an extended section of the measuring device, at a point (five feet in this embodiment) at which the number of lines may be changed. First section 902 has four lines of holes while second section 904 has a fifth line of holes. As the device of the invention allows extended measurement and marking (unlike short hand held devices like carpenter's squares) it is desirable to have extended lines of holes for marking.

In one method of use of the present invention, the user of the device may carry out the following steps.
1) Provide a flexible retractable tape measure having a plurality of holes arrayed in two straight parallel longitudinal lines, each line having holes arrayed at a distance of ⅛ inch distance, the two lines of holes offset by a longitudinal distance of 1/16 inch from each other, the tape measure having a first end and a second end;
2) Place the first end at a first point;
3) Extend the flexible retractable tape measure second end to a length exceeding a first desired measurement from the first point;
4) Locate one hole of the two lines of holes which hole is located at the first desired distance;
5) Insert the tip of a marking device through the located hole;
6) Scribe a mark on the item through the located hole, and
7) If an arc is desired, maintain the marking device in the hole while rotating the tape measure about an axis located at the first point, so as to inscribe an arc on the item, the arc having a uniform distance from the first point,
8) Optionally, insert an axis (a pointed object) through the first end of the device prior to scribing the arc mark,
9) If a line parallel to an edge is desired, position an end of the device at the edge, then pull the device along the edge, maintaining it perpendicular to the edge, while scribing a line through the located hole.

FIG. 10 is a top view of a the method of the invention of drawing a line parallel to an edge with the device of the invention. Edge 333 has hook 307 passing over it. Holding the device in tension against the edge, the user pulls the device parallel to the edge with marking device 334 (pen, pencil, pointed object, nail, etc) inserted through a selected hole, thereby scribing a line parallel to the edge 333. Where the edge 333 is straight, the line will be straight, where the edge moves in or out (curving, etc) the line will follow. A button or slide on the housing (not numbered) may allow the user to lock the device in place, aiding the user in maintaining the device in tension from the edge.

FIG. 11 is a diagram showing another axis hole, in this case located at a ten inch mark of the device. The axis hole and nail head combination 1102 provides axis 1102 for exact marking of arcs, superior to devices having only a single hole (the marking hole).

FIG. 12 is a planform diagram showing a section of the tame measure near the end, and an exemplary set of holes and marks suitable for the method and device of the present invention.

The disclosure is provided to allow practice of the invention by those skilled in the art without undue experimentation, including the best mode presently contemplated and the presently preferred embodiment. Nothing in this disclosure is to be taken to limit the scope of the invention, which is susceptible to numerous alterations, equivalents and substitutions without departing from the scope and spirit of the invention. The scope of the invention is to be understood from the appended claims.

What is claimed is:

1. A method of measuring and marking on an item, the method comprising the steps of:
providing a flexible retractable long tape measure having a plurality of holes arrayed in two straight parallel longitudinal lines, each line having holes arrayed at a first separation distance, the two lines of holes offset by a longitudinal offset distance from each other, the tape measure having a first end and a second end;
placing the first end at a first point;
extending the flexible retractable tape measure second end to a length exceeding a first desired measurement from the first point;
locating one hole of the two lines of holes which hole is located at the first desired distance;
inserting the tip of a marking device through the located hole; and
scribing a mark on the item through the located hole.

2. The method of claim 1, further comprising:
maintaining the marking device in the located hole; while
rotating the tape measure about an axis located at the first point, the axis being a pointed object inserted through an axis hole in the tape measure at the first point; whereby
an arc is scribed on the item, the arc having a uniform distance from the first point.

3. The method of claim 1, further comprising:
after placing the first end at the first point, scribing a mark at the first end.

4. A working measurement and marking device comprising:
a housing;
a long flexible measure having a first extended position outside the housing and having a second retracted position within the housing;
a first line of holes passing through the flexible measure, the line straight and parallel to the length of the flexible measure, the holes of the first line of holes being disposed a first separation distance apart, the holes of the first line having a first diameter.

5. The working measurement and marking device of claim 4, further comprising:
a second line of holes passing through the flexible measure, the line straight and parallel to the length of the flexible measure, the holes of the second line of holes being disposed a second separation distance apart, the holes of the second line having a second diameter, and the holes of the second line offset by a longitudinal offset distance from the holes of the first line whereby the holes of the two lines are staggered.

6. The working measurement and marking device of claim 5, wherein the first and second diameter are equal to 0.0625 inch.

7. The working measurement and marking device of claim 6, wherein those holes of the first and second lines of holes which are located at an even measurement of 1 inch have a third diameter, the third diameter being larger than the first and second diameter.

8. The working measurement and marking device of claim 7, wherein the third diameter is 0.125 inch.

9. The working measurement and marking device of claim 4, wherein the flexible measure further comprises:
a metal tape.

10. The working measurement and marking device of claim 9, wherein the metal tape further comprises:
a plurality of indicia of distance.

11. The working measurement and marking device of claim 4, wherein the housing further comprises:
a magnet.

12. The working measurement and marking device of claim 5, wherein the first and second diameter are equal to 0.5 millimeter.

13. The working measurement and marking device of claim 6, wherein those holes of the first and second lines of holes which are located at an even measurement of 1 centimeter have a third diameter, the third diameter being larger than the first and second diameter.

14. The working measurement and marking device of claim 7, wherein the third diameter is 1 millimeter.

15. The working measurement and marking device of claim 4, further comprising:
third and fourth lines of holes.

16. The working measurement and marking device of claim 15, further comprising:
a fifth line of holes, the first four lines of holes disposed on a first portion of the length of the flexible measure, the fifth line of holes disposed upon the flexible measure on a second portion of the length of the flexible measure.

17. The working measurement and marking device of claim 16, further comprising:
an axis hole disposed separately from any line of holes.

18. The working measurement and marking device of claim 17, wherein the long measure further comprises a length of at least 6 feet.

18. A working measurement and marking device comprising:
a housing;
a flexible measure having a first extended position outside the housing and having a second retracted position within the housing, the flexible measure having first and second edges;
a first line of notches along the first edge of the flexible measure, the notches of the first line of notches being disposed a first separation distance apart.
